(19) United States
(12) Patent Application Publication
(10) Pub. No.: US 2025/0368327 A1
(43) Pub. Date: Dec. 4, 2025

(54) Midair Item Dispenser Systems and Methods

(71) Applicant: Roy L. Fox, Jr., Yuma, AZ (US)

(72) Inventor: Roy L. Fox, Jr., Yuma, AZ (US)

(21) Appl. No.: 18/830,179

(22) Filed: Sep. 10, 2024

Related U.S. Application Data
(60) Provisional application No. 63/583,479, filed on Sep. 18, 2023.

(51) Int. Cl. B64D 1/02; B64D 17/24

(52) U.S. Cl. CPC B64D 1/02; B64D 17/24

(57) ABSTRACT

A midair dispenser can include a motor mounted to a housing, and a lead screw disposed at least partially within the housing. The midair dispenser further includes a lead nut threadingly coupled to the lead screw, and a support fixed with respect to the housing and extending along the lead screw. The support stops the lead nut from rotating together with the lead screw. The motor is configured to rotate the lead screw with respect to the support to cause the lead nut to translate along the lead screw to release an item from the midair dispenser. The motor can selectively release the item(s) (e.g., sequentially and/or simultaneously) from the midair dispenser while suspended in the air.

### CROSS REFERENCE TO RELATED APPLICATIONS

This application claims priority to, and the benefit of, U.S. Provisional Patent Application Ser. No. 63/583,479, entitled “MIDAIR ITEM DISPENSER SYSTEMS AND METHODS,” filed on Sep. 18, 2023. The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to midair release systems, and particularly to apparatus, systems, and methods for midair releasing of items.

### BACKGROUND

Conventionally, a payload may be secured on top of a delivery platform by one or more lashings or tie downs. These lashings and/or tie downs are designed to be removed/released by an operator (on land or at sea) when the payload is to be used. For example, if a platform is used to deliver a payload by parachute aerial delivery, the payload is released from the platform when an operator reaches the platform after it has landed. In this example, the platform has already landed before the operator is able to reach the platform. Accordingly, improved systems and methods for midair payload release are desirable.

### SUMMARY

One aspect of the subject matter described in this disclosure may be embodied in a midair dispenser. The midair dispenser can include a housing, a motor mounted to the housing, a lead screw disposed at least partially within the housing, the motor is configured to control a rotational position of the lead screw, a lead nut threadingly coupled to the lead screw, and a support fixed with respect to the housing and extending along the lead screw, the support stops the lead nut from rotating together with the lead screw. The motor is configured to rotate the lead screw with respect to the support to cause the lead nut to translate along the lead screw to release an item from the midair dispenser.

These and other embodiments may optionally include one or more of the following features. The lead nut can be configured to decouple from the lead screw to release the item from the midair dispenser. The support can be a tube at least partially surrounding the lead screw. The tube can include a slot extending longitudinally along the tube. The midair dispenser can further include a beam coupled to the lead nut and extending through the slot. The beam can be a cantilevered beam. The midair dispenser can further include a conformable material coupled to the beam and configured to interface the item. The housing can be configured to be suspended from a parachute.

In another aspect, the subject matter may be embodied in a midair dispenser including a housing, a first motor mounted to the housing, a first lead screw disposed at least partially within the housing, the first motor is configured to control a rotational position of the first lead screw, and a first lead nut threadingly coupled to the first lead screw. The first motor is configured to rotate the first lead screw to cause the first lead nut to translate along the first lead screw to release a first item from the midair dispenser.

These and other embodiments may optionally include one or more of the following features. The midair dispenser can further include a second motor mounted to the housing, a second lead screw disposed at least partially within the housing, the second motor is configured to control a rotational position of the second lead screw, and a second lead nut threadingly coupled to the second lead screw. The midair dispenser can further include a beam extending between and to the first lead nut and the second lead nut, and the first motor and the second motor are configured to control the first lead screw and the second lead screw in unison for moving the first item between a stowed position and a releasable position. The midair dispenser can further include a first support fixed with respect to the housing and extending along the first lead screw, the first support stops the first lead nut from rotating together with the first lead screw. The midair dispenser can further include a second lead nut coupled to the first lead screw, and the first motor is configured to rotate the first lead screw to cause the second lead nut to translate along the first lead screw to release a second item from the midair dispenser. The midair dispenser can further include a first beam extending from the first lead nut, and a second beam extending from the second lead nut, and the first item is configured to be supported between the first beam and the second beam. The midair dispenser can further include a first conformable material disposed on the first beam, and a second conformable material disposed on the second beam, and the first item is configured to be supported between the first conformable material and the second conformable material. The housing can be open at a bottom end thereof to provide an exit for the first item. The midair dispenser can further include a beam extending from the first lead nut, the beam includes a surface configured to conform to the first item.

In another aspect, the subject matter may be embodied in a method of releasing an item midair. The method can include controlling, by a processor, a motor to rotate a lead screw, translating a lead nut along the lead screw, and moving a first item together with the lead nut from a stowed position to a releasable position.

These and other embodiments may optionally include one or more of the following features. The method can further include translating the lead nut past an end of the lead screw to release the lead nut and the first item from the lead screw. The method can further include supporting the first item with a beam extending from the lead nut, and releasing the first item from the beam when the lead nut is moved to the releasable position.

The contents of this summary section are provided only as a simplified introduction to the disclosure and are not intended to be used to limit the scope of the appended claims.

### BRIEF DESCRIPTION OF THE DRAWINGS

With reference to the following description, appended claims, and accompanying drawings:

FIG. 1 illustrates a midair dispenser suspended from a parachute assembly, in accordance with an embodiment of the present disclosure.

FIG. 2 illustrates a schematic view of a midair dispenser, in accordance with an embodiment of the present disclosure.

FIG. 3 illustrates a schematic section view of a plurality of lead screws for a midair dispenser, taken along a plane perpendicular to the longitudinal axes of the lead screws, in accordance with an embodiment of the present disclosure.

FIG. 4 illustrates a schematic perspective view of a lead screw and lead screw housing (also referred to herein as a support), and a slot disposed in the lead screw housing, in accordance with an embodiment of the present disclosure.

FIG. 5 illustrates a schematic side view of a lead screw assembly supporting a releasable item, in accordance with an embodiment of the present disclosure.

FIG. 6 illustrates a schematic top view of a lead screw assembly supporting a releasable item, in accordance with an embodiment of the present disclosure.

FIG. 7 illustrates a schematic view of a releasable item integrally coupled with a lead nut, in accordance with an embodiment of the present disclosure.

FIG. 8 illustrates a schematic view of a releasable item removably coupled with a lead nut and support beam, in accordance with an embodiment of the present disclosure.

FIG. 9 illustrates a schematic view of a releasable item removably coupled with a lead nut and support beam extending at least partially through a portion of the releasable item, in accordance with an embodiment of the present disclosure.

FIG. 10 illustrates a schematic view of a support beam having a conformable material for interfacing with a releasable item, in accordance with an embodiment of the present disclosure.

FIG. 11 illustrates a schematic view of a pair of lead nuts having a support beam extending therebetween, in accordance with an embodiment of the present disclosure.

FIG. 12 illustrates a schematic view of an anti-rotation arrangement including a smooth rod and a threaded rod arranged in parallel, in accordance with an embodiment of the present disclosure.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

Disclosed herein are systems, methods, and devices for implementing a midair dispenser for releasing one or more items (e.g., payload). Aspects and/or embodiments are directed to a lead screw apparatus for midair release of one or more releasable items. The apparatus can both secure the releasable item, or items, to or within the dispenser and, additionally, control the timing by which the releasable item, or items, is dispensed. Moreover, the apparatus can secure and/or release multiple items of different types, shapes, sizes, etc. Stated differently, the apparatus is not limited to securing and/or releasing only one type of releasable item. Moreover, the apparatus can be adapted for dispensing relatively fragile items (e.g., a helicopter type drone).

Systems, apparatus, and methods of the present disclosure can be used for a great variety of applications, mostly applications in which it is desirable to provide a payload to an area which is not accessible by human beings, and/or that the conditions in the area put humans in too great of a risk to deliver the payload. Examples of such applications can be fire distinguishing Unmanned Aerial Vehicles (UAVs) configured for dispersing water and flame-retardant substances over a burning area (e.g., a forest fire), dispersion of pesticides, delivery of supplies (medical, food and otherwise) to inaccessible areas, delivery of supplies to inaccessible areas such as war zones, etc.

For the sake of brevity, conventional techniques for lead screws and/or the like may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical system for lead screws and/or related methods of use.

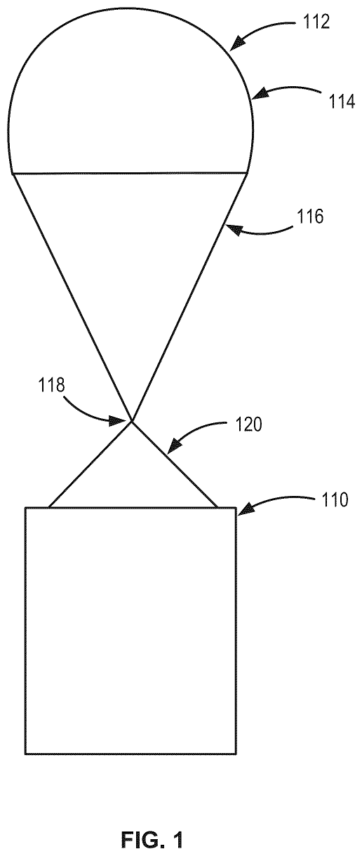

With reference to FIG. 1, in accordance with various embodiments, a midair dispenser 110 (also referred to herein as a midair item dispenser) is illustrated being suspended midair. In the illustrated embodiment, the midair dispenser 110 is shown suspended from a parachute 112; however, a midair dispenser 110 can be suspended from any suitable apparatus, including a parachute, a helicopter, an airplane, a balloon, a crane, etc. The parachute 112 can include a canopy 114 and a plurality of suspension lines 116 coupled to main canopy 114, for example, at the edges of canopy 114. The suspension lines 116 can be connected to canopy 114 and can descend therefrom to lower ends for attachment to a load (e.g., midair dispenser 110). A plurality of suspension lines 116 may converge (or couple to one another) at a convergence point 118. Although one convergence point 118 is illustrated for ease of illustration, additional convergence points (e.g., two, three, four, five, six, or more) can be disposed equidistantly about the canopy 114 whereby a plurality of immediately adjacent suspension lines converge. In the illustrated embodiment, convergence point 118 is coupled to suspension slings 120; though in other embodiments convergence point 118 can be coupled directly to a payload (e.g., without the use of suspension slings 120). The suspension slings 120 can be configured to secure the midair dispenser 110 to the parachute 112. The suspension slings 120 can be configured to reduce shock experienced by cargo midair dispenser 110 and/or the parachute system itself. The suspension slings 120 can extend between and to the midair dispenser 110 and the suspension lines 116 to suspend the midair dispenser 110 in an upright position.

In various embodiments, midair dispenser 110 is configured to secure one or more items and release the item(s) while the midair dispenser 110 is suspended above a surface midair. For example, the midair dispenser 110 can be dropped from an aircraft over an area at or near a desired dispersion zone and the item(s) can be released from the dispenser 110.

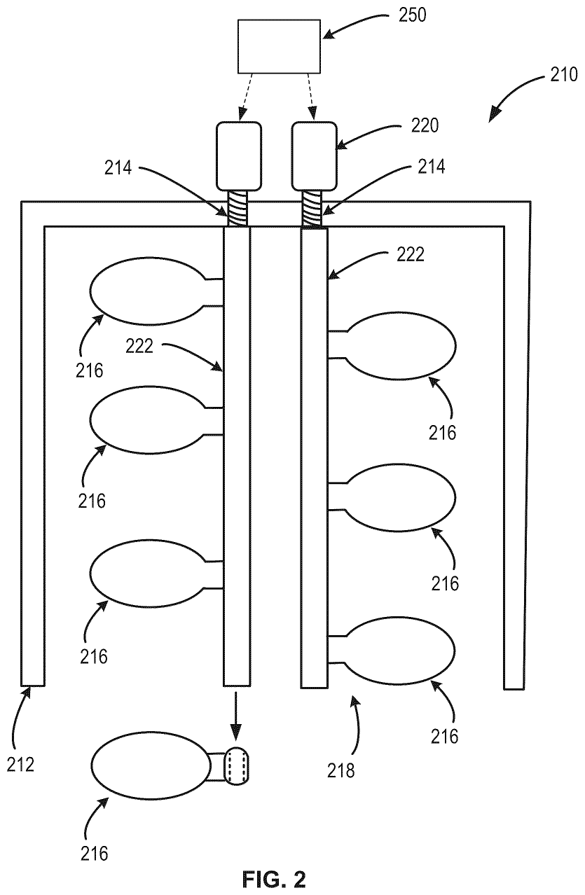

FIG. 2 is an example midair dispenser 210 (also referred to herein as a midair item dispenser) having a housing 212 and a plurality of lead screws 214 configured to selectively move a plurality of releasable items 216 from respective stowed positions to releasable positions. The housing 212 can be provided in the form of a box or a cage and can be suspended above a surface by any suitable means, as described herein. The housing 212 can have an opening 218 whereby the releasable items 216 can exit the housing 212. In the illustrated embodiment, the opening 218 is located at a lower end of the housing 212 (i.e., the lower end of the housing is open). However, it is contemplated that the opening 218 can be located at any suitable portion of the housing 212. In various embodiments, the opening 218 can be covered by a door or panel that is removable (or opened) before dispensing the releasable item(s) 216.

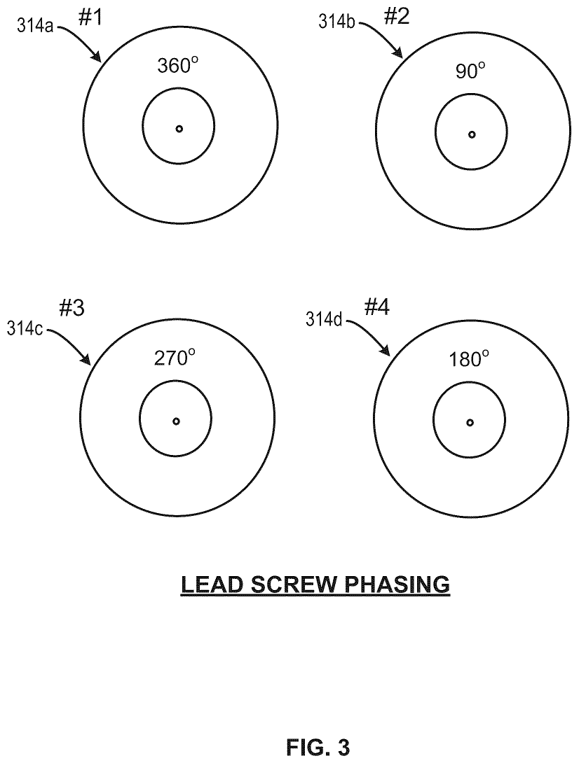

The midair dispenser 210 can include one or more motors 220 for controlling rotation of the lead screw(s) 214. The motor 220 can be an electric motor, a pneumatic motor, a spring driven motor, or any other suitable motor 220 for rotating the lead screws 214. If more than one lead screw 214 is utilized for a single midair dispenser 210, each lead screw 214 can be equipped with a dedicated drive motor 220, or the lead screws 214 can be linked mechanically to permit one motor to cause rotation of a plurality of lead screws 214. If multiple lead screws 214 are used, the lead screws 214 may be linked, mechanically or electrically, as a means by which the dispensing rate and/or sequencing intervals may be controlled. Moreover, the releasable items 216 can be dispensed either sequentially or simultaneously. For example, FIG. 3 illustrated a section view taken along a horizontal plane of a midair dispenser where each lead screw 314a, 314b, 314c, 314d is rotated out of phase with respect to the other lead screws 314a, 314b, 314c, 314d. In this manner, where a plurality of releasable items are held in a horizontal plane (i.e., a plane that is perpendicular to the longitudinal axes of the lead screws), the lead screws 314a, 314b, 314c, 314d can be actuated (i.e., rotated) to release the releasable items sequentially. In other embodiments the lead screws 314a, 314b, 314c, 314d are controlled to release the releasable items (those releasable items that are in a common horizontal plane) simultaneously.

With reference to FIG. 2, a plurality of supports 222 extend in parallel with the lead screws 214. Each support 222 can be vertically suspended from the housing 212. Each support 222 can be a tube or rod. The support 222 can be a round tube or rod or can be a polygonal tube or rod (e.g., a rectangular or square tube). The support 222 can be a smooth tube or rod (i.e., having a smooth outer surface). The support 222 can engage the releasable item 216 and prevent the releasable item 216 from rotating together with the lead screw 214. In this manner, the lead screw 214 can rotate with respect to the support 222 and releasable item 216. The releasable item 216 can be threadingly coupled to the lead screw 214 such that rotational motion of the lead screw 214 is converted into linear translation of the releasable item 216.

The midair dispenser 210 can further include a control unit 250, which includes one or more controllers (e.g., processors) and one or more tangible, non-transitory memories capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, the control unit 250 controls, at least various parts of, and operation of various components of, the midair dispenser 210. For example, the control unit 250 controls the motor(s) 220, thereby controlling a rotational position of the lead screw(s) 214, thereby controlling a linear position of the releasable item(s) 216.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

A memory may be coupled to the control unit 250 and store instructions that the control unit 250 executes. The memory may include one or more of a Random Access Memory (RAM) or other volatile or non-volatile memory. The memory may be a non-transitory memory or a data storage device, such as a hard disk drive, a solid-state disk drive, a hybrid disk drive, or other appropriate data storage, and may further store machine-readable instructions, which may be loaded and executed by the control unit 250 or other processor. For example, the memory can store rotational positions of the lead screw(s) 214 corresponding with various positions of the releasable item(s) 216. The memory can store instructions in accordance with any of the methods described herein for monitoring and/or controlling various components of the midair dispenser 210 as described herein.

Along the length of the support 222 may be one of more latching mechanisms to allow the releasable item(s) 216 to be in a first stowed location and then in a releasable location. Between the first stowed location and the releasable location may be intermediate stowage locations. These locations may be defined as positions whereby there is a latching means that will releasably secure the releasable item to the tube or rod at a discrete location. The movable portion of the latching means may be an element of the support 222, which will interface with the releasable item 216. Alternatively, the movable portion of the latching means may be an element of the releasable item 216, which will interface with the support 222.

In various embodiments, if a ferrous material is incorporated, the securing and releasing means may be an electromagnet. Powered by gravity, the releasable item 216 may move controllably from an upper stowed location to a lower releasable location and, if desired, to intermediate stowed locations.

In various embodiments, a receptacle matching the profile of the support 222 is provided in or on the releasable item 216. The receptacle can be a threaded hole in the releasable item 216. The releasable item 216 can translate along the support 222 via the receptacle. For example, the support 222 can be received through the receptacle.

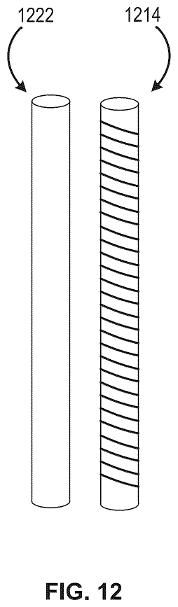

In various embodiments, if the support 222 is circular instead of polygonal, another means, such as a parallel tube/rod (for example, a non-threaded rod 1222 in parallel with a threaded rod 1214 as shown in the exemplary embodiment of FIG. 12) or other type of anti-rotation means can be provided to prevent the releasable item 216 from rotating on the support 222 prior to the releasable item 216 being dispensed.

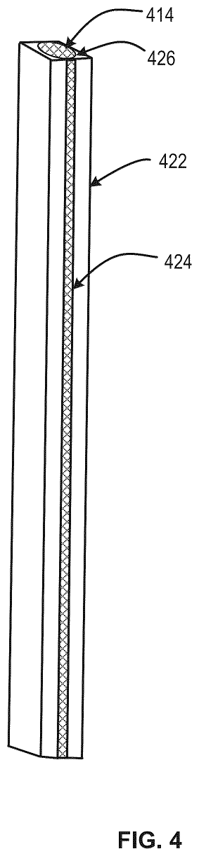

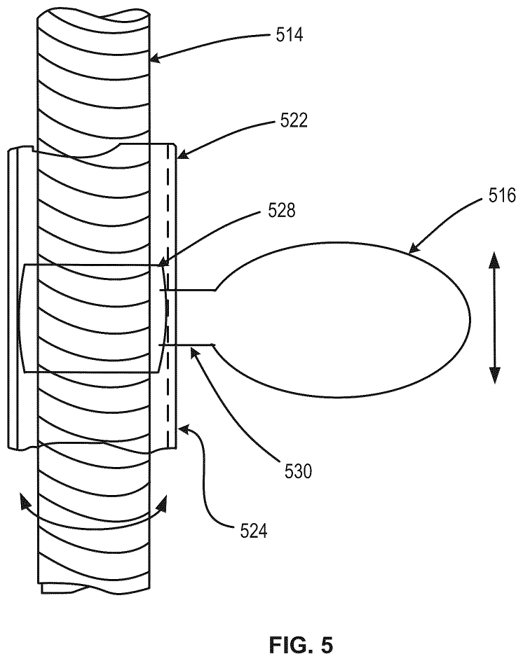

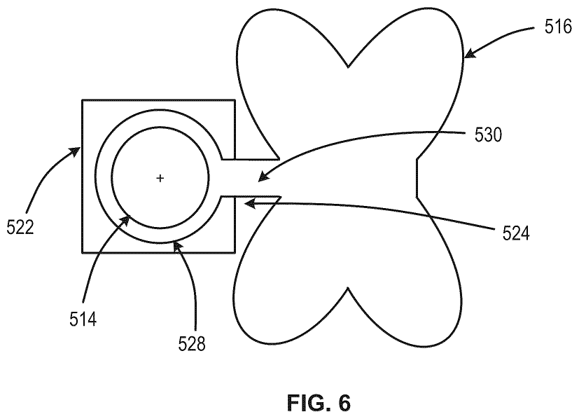

In various embodiments, the support 222 is a slotted tube, for example as illustrated in FIG. 4 through FIG. 6. With reference to FIG. 4, a support 422 is illustrated having a longitudinally extending slot 424. The slotted support 422 can house the lead screw 414. The support 422 can be either cylindrical or polygonal. The lead screw can extend through the support 422. For example, the support 422 can have a bore 426 extending therethrough, whereby the lead screw 414 is threadingly coupled to the support 422. An element of the releasable item (e.g., releasable item 216 of FIG. 2) can interface with the lead screw via the slot 424 (e.g., see FIG. 5 and FIG. 6). With such a configuration, the releasable item can smoothly and controllably move from an upper location to a lower location, due to the lead screw 414 being rotated, with a stop anywhere between, if the lead screw 414 rotation is halted. If multiple, parallel, lead screws 414 and lead screw housings (i.e., supports 422) are suspended from the upper structure of the midair dispenser (e.g., housing 212 of FIG. 2), with adequate horizontal separation between them, and each has one or more releasable items suspended by it, the lead screws 414 may be rotated individually, or they may be rotated in unison, so that the releasable items (e.g., releasable items 216 of FIG. 2) may be released at any desired interval and/or sequence.

With reference to FIG. 5, the midair dispenser can include a lead nut 528 threadingly coupled to the lead screw 514. A beam 530 can extend from the lead nut 528 through the slot 524 in the support 522 (also referred to as a lead screw housing). The beam 530 can be a cantilevered beam (i.e., supported only at one end via the lead nut 528. The beam 530 can protrude horizontally (i.e., left to right in FIG. 5) from the lead nut 528. The beam 530 can extend between and to the releasable item 516 and the lead nut 528. The lead nut 528 can be a low friction interface nut, having internal threads that match the external threads on the lead screw 514. The beam 530, passing through the lead screw housing slot 524, can prevent the releasable item 516 from rotating as the lead screw 514 rotates. Assuming conventional right-hand threads, when the lead screw 514 is rotated clockwise the releasable item will be lifted toward the top of the midair dispenser and the opposite will occur if the lead screw 514 is rotated counterclockwise. If the lead screw 514 is rotated counterclockwise, sufficiently, the lead nut 528 will disengage from the bottom end of the lead screw 514 and the releasable item 516 will no longer be mechanically attached to the midair dispenser.

FIG. 6 is a top view of the releasable item 516 threadingly coupled to the lead screw 514 via the lead nut 528 and the beam 530.

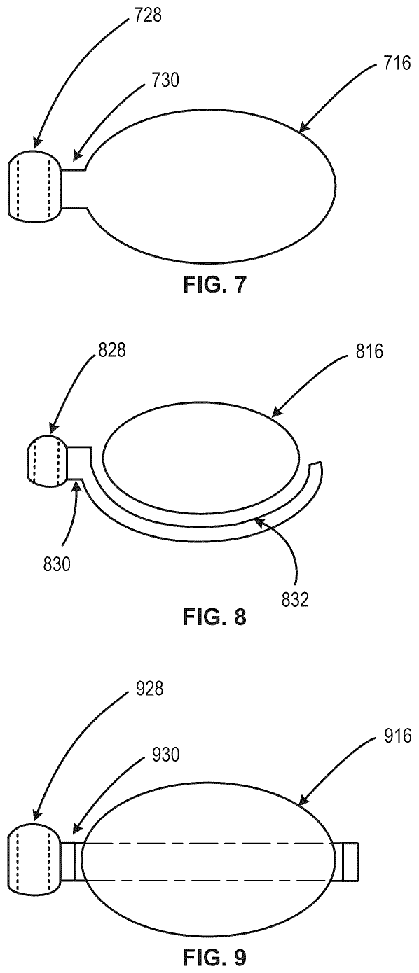

With reference to FIG. 7, the cantilevered beam 730 and interfacing lead nut 728 can be integrated as a physical element of the releasable item 716. For example, the releasable item 716, lead nut 728, and beam 730 can be coupled as a single unit.

With reference to FIG. 8, the releasable item 816 can be a separate, stand-alone, element from the cantilevered beam 830 and lead nut 828. The releasable item 816 can be a form-fitting item. For example, the beam 830 can include a conforming surface 832 configured to conform to a profile of the releasable item 816. The releasable item 816 can rest against the conforming surface 832 until the releasable item 816 is dispensed.

With reference to FIG. 9, the releasable item 916 can be a separate, stand-alone, element from the cantilevered beam 930 and lead nut 928. The beam 930 can extend at least partially through a portion of the releasable item 916 for securing the releasable item 916 to the beam 930.

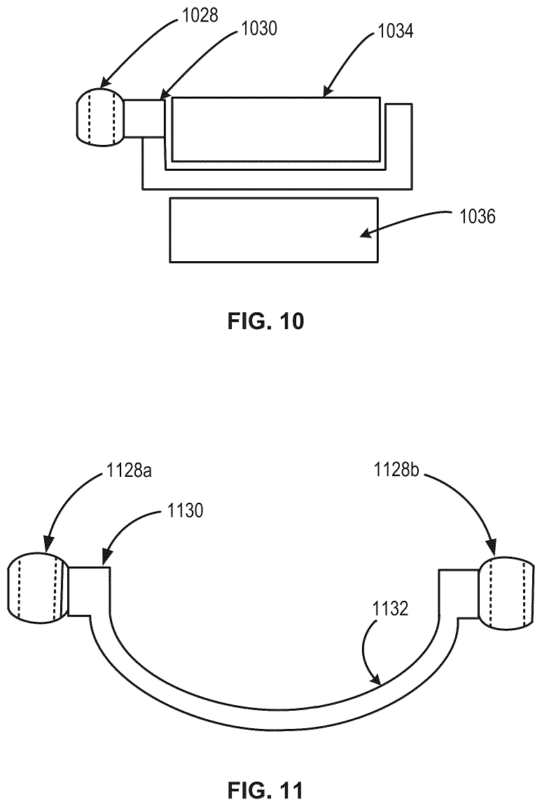

With reference to FIG. 10, the beam 1030 can extend from the lead nut 1028 and include a conformable material 1034 (e.g., rubber, foam, etc.) coupled to a top surface thereof. The releasable item can rest against the conformable material 1034 until the releasable item 816 is dispensed. The beam 1030 can further include a conformable material 1036 (e.g., rubber, foam, etc.) coupled to a bottom surface thereof. In this manner, a second releasable item can be supported between the conformable material 1036 and a second beam disposed beneath the first beam 1030 (i.e., the releasable item can be secured vertically between a first beam 1030 and a second beam 1030. In this manner, additional stabilization to the releasable item between two beams 1030 can be provided. The conformable material 1034 can conform to a bottom surface of the releasable item and the conformable material 1036 can conform to a top surface of the releasable item.

With reference to FIG. 11, a first lead screw assembly can be paired with a second lead screw assembly. In this manner, a beam 1130 can extend between and to a first lead nut 1128a and a second lead nut 1128b. In this manner, the beam 1130 can support additional mass of the releasable item. Moreover, coupling the beam 1130 between two lead nuts 1128a, 1128b can prevent a single lead screw from being overloaded. The beam 1130 can include a conforming surface 1132 configured to interface with a releasable item.

In an example method, and with combined reference to FIG. 2 and FIG. 5, the control unit 250 can control the motor 220 to rotate the lead screw 514. In response to the lead screw 514 rotating, the lead nut 528 can translate along the lead screw 514. The releasable item can move together with the lead nut 528 from a stowed position to a releasable position. In various embodiments, the method can further include translating the lead nut 528 past an end of the lead screw 514 (e.g., a releasable position) to release the lead nut 528 and the releasable item 516 from the lead screw 514. The method can further include supporting the releasable item 516 with the beam 530 extending from the lead nut 528. The method can further include releasing the releasable item 516 from the beam 530 when the lead nut 528 is moved to the releasable position. For example, the releasable item 516 can be removably couped to the beam 530 (see, for example, FIG. 8).

Principles of the present disclosure may be compatible with and/or utilize certain components or techniques disclosed in other U.S. Patents and/or U.S. Patent applications, including but not limited to: (i) U.S. Pat. No. 9,789,968 to Fox entitled “RING RELEASE SYSTEM AND METHODS”; (ii) U.S. Pat. No. 9,452,842 to Fox entitled “PARACHUTE CANOPY INSERT”; (iii) U.S. Pat. No. 9,399,514 to Fox entitled “AERIAL DELIVERY SYSTEM WITH MUNITION ADAPTER AND LATCHING RELEASE”; (iv) U.S. Pat. No. 8,864,080 to Fox entitled “EXPENDABLE AERIAL DELIVERY SYSTEM”; (v) U.S. Pat. No. 8,851,426 to Fox entitled “ENHANCED CRUCIFORM PARACHUTE”; (vi) U.S. Pat. No. 8,313,063 to Fox entitled “PARACHUTE RELEASE SYSTEM AND METHOD”; (vii) U.S. Pat. No. 8,210,479 to Fox entitled “PARACHUTE INLET CONTROL SYSTEM AND METHOD”; (viii) U.S. Pat. No. 8,096,509 to Fox entitled “AERIAL DELIVERY SYSTEM”; (ix) U.S. Pat. No. 8,083,104 to Fox entitled “AERIAL DELIVERY SYSTEM”; (x) U.S. Pat. No. 7,967,254 to Fox entitled “SLING RELEASE MECHANISM”; (xi) U.S. Pat. No. 7,264,205 to Fox entitled “PARACHUTE RELEASE APPARATUS”; (xii) U.S. Pat. No. 7,261,258 to Fox entitled “CRUCIFORM PARACHUTE DESIGN”; (xiii) U.S. Pat. No. 6,994,295 to Fox entitled “QUONSET TYPE PARACHUTE”; (xiv) U.S. Pat. No. 6,843,451 to Fox entitled “PARACHUTE SLIDER REEFING WITH FRICTION INDUCED RETARDATION”; (xv) U.S. Pat. No. 6,290,177 to Fox entitled “BI-DIRECTIONAL PILOT PARACHUTE RELEASE ASSEMBLY”; and (xvi) U.S. Pat. No. 10,689,123 to Fox entitled “PARACHUTE INLET CONTROL SYSTEM AND METHOD.” Each of the foregoing are hereby incorporated by reference in their entireties for all purposes (but except for any subject matter disclaimers or disavowals, and except to the extent that the incorporated material is inconsistent with the express disclosure herein, in which case the language in this disclosure shall control).

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

In the foregoing specification, various embodiments have been described. However, one of ordinary skill in the art appreciates that various modifications and changes can be made without departing from the scope of the present disclosure as set forth in the claims below. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A midair dispenser comprising:
a housing;
a motor mounted to the housing;
a lead screw disposed at least partially within the housing, the motor is configured to control a rotational position of the lead screw;
a lead nut threadingly coupled to the lead screw; and
a support fixed with respect to the housing and extending along the lead screw, the support stops the lead nut from rotating together with the lead screw, and the motor is configured to rotate the lead screw with respect to the support to cause the lead nut to translate along the lead screw to release an item from the midair dispenser.

2. The midair dispenser of claim 1, wherein the lead nut is configured to decouple from the lead screw to release the item from the midair dispenser.

3. The midair dispenser of claim 1, wherein the support is a tube at least partially surrounding the lead screw.

4. The midair dispenser of claim 3, wherein the tube includes a slot extending longitudinally along the tube.

5. The midair dispenser of claim 4, further comprising a beam coupled to the lead nut and extending through the slot.

6. The midair dispenser of claim 5, wherein the beam is a cantilevered beam.

7. The midair dispenser of claim 5, further comprising a conformable material coupled to the beam and configured to interface the item.

8. The midair dispenser of claim 1, wherein the housing is configured to be suspended from a parachute.

9. A midair dispenser comprising:
a housing;
a first motor mounted to the housing;
a first lead screw disposed at least partially within the housing, the first motor is configured to control a rotational position of the first lead screw; and
a first lead nut threadingly coupled to the first lead screw, and the first motor is configured to rotate the first lead screw to cause the first lead nut to translate along the first lead screw to release a first item from the midair dispenser.

10. The midair dispenser of claim 9, further comprising:
a second motor mounted to the housing;
a second lead screw disposed at least partially within the housing, the second motor is configured to control a rotational position of the second lead screw; and
a second lead nut threadingly coupled to the second lead screw.

11. The midair dispenser of claim 10, further comprising a beam extending between and to the first lead nut and the second lead nut, and the first motor and the second motor are configured to control the first lead screw and the second lead screw in unison for moving the first item between a stowed position and a releasable position.

12. The midair dispenser of claim 9, further comprising a first support fixed with respect to the housing and extending along the first lead screw, the first support stops the first lead nut from rotating together with the first lead screw.

13. The midair dispenser of claim 9, further comprising a second lead nut coupled to the first lead screw, and the first motor is configured to rotate the first lead screw to cause the second lead nut to translate along the first lead screw to release a second item from the midair dispenser.

14. The midair dispenser of claim 10, further comprising:
a first beam extending from the first lead nut; and
a second beam extending from the second lead nut, and the first item is configured to be supported between the first beam and the second beam.

15. The midair dispenser of claim 14, further comprising:
a first conformable material disposed on the first beam; and
a second conformable material disposed on the second beam, and the first item is configured to be supported between the first conformable material and the second conformable material.

16. The midair dispenser of claim 9, wherein the housing is open at a bottom end thereof to provide an exit for the first item.

17. The midair dispenser of claim 9, further comprising a beam extending from the first lead nut, the beam includes a surface configured to conform to the first item.

18. A method of releasing an item midair, the method comprising:
controlling, by a processor, a motor to rotate a lead screw;
translating a lead nut along the lead screw; and
moving a first item together with the lead nut from a stowed position to a releasable position.

19. The method of claim 18, further comprising translating the lead nut past an end of the lead screw to release the lead nut and the first item from the lead screw.

20. The method of claim 18, further comprising supporting the first item with a beam extending from the lead nut, and releasing the first item from the beam when the lead nut is moved to the releasable position.
